(19) United States
(12) Patent Application Publication
(10) Pub. No.: US 2023/0410721 A1
(43) Pub. Date: Dec. 21, 2023

(54) ILLUMINATION PORTIONS ON DISPLAYS

(71) Applicant: Hewlett-Packard Development Company, L.P., Spring, TX (US)

(72) Inventors: Joshua Glenn Little, Palo Alto, CA (US); Cheng-Tsung Wu, Taipei (TW); Ron Y. Zhang, Fort Collins, CO (US); Vincent Thai Nguyen, Palo Alto, CA (US); Jae Woo Chung, Palo Alto, CA (US)

(21) Appl. No.: 18/250,083

(22) PCT Filed: Oct. 23, 2020
(86) PCT No.: PCT/US2020/057052

§ 371 Date: Apr. 21, 2023

(51) Int. Cl. G09G 3/22; G09G 5/10; G06F 3/0482

(52) U.S. Cl. CPC G09G 3/22; G09G 5/10; G06F 3/0482; G09G 2320/0626; G09G 2320/0666; G09G 2320/0686; G09G 2360/144

(57) ABSTRACT

In some examples, a computing device can include a processor resource and a non-transitory memory resource storing machine-readable instructions stored thereon that, when executed, cause the processor resource to: generate, on a display, a first layer that includes selectable inputs, generate, on the display, a second layer on the first layer to generate an illumination above a threshold illumination on a portion of the display, and provide, on the display, interaction with the selectable inputs of the first layer when the selectable inputs are covered by the second layer.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry or otherwise bring the computing device with while in a mobile setting. These computing devices can be utilized to provide video conferencing between computing devices and/or generate images that can be transferred between computing devices.

### BRIEF DESCRIPTION OF THE DRAWINGS

FIG. 1 illustrates an example of a system including a computing device for generating illumination portions on a display.

FIG. 2 illustrates an example of a memory resource storing instructions for generating illumination portions on a display.

FIG. 3 illustrates an example of a system including a computing device for generating illumination portions on a display.

FIG. 4 illustrates a display with generated illumination portions.

FIG. 5 illustrates a display with generated illumination portions.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, an all-in-one (AIO) computer, networking device (e.g., router, switch, etc.), and/or a mobile device (e.g., a smart phone, tablet, personal digital assistant, smart glasses, a wrist-worn device such as a smart watch, etc.), among other types of computing devices. As used herein, a mobile device refers to devices that are (or can be) carried and/or worn by a user.

In some examples, the computing devices can instruct imaging devices to capture images. As used herein, the term “imaging device” is a device that can capture or record visual images. In some examples, the imaging device can include a photographic camera, infrared camera, or similar device to capture images. For example, the imaging device can be a video camera to record or sequence a plurality of images that can be in a video format. Although video cameras are utilized as examples herein, the disclosure is not so limited. In some examples, the imaging device can be a front facing imaging device or imaging device that is directed in the same or similar direction as a display. In some examples, a front facing imaging device can be utilized for video conferencing, capturing still images, and/or capturing video images. In previous systems, front facing imaging devices may utilize separate lighting devices to provide illumination on a subject. As used herein, a separate lighting device or peripheral lighting device can include a lighting device that is physically distinct from the imaging device and/or not manufactured to be associated with the imaging device. Separate lighting devices can be relatively expensive and may be difficult to correctly set up to adequately illuminate a subject so as to improve a quality of an image of such subject. Separate lighting devices can also be difficult to utilize with mobile computing devices and may be difficult to synchronize with the imaging device.

The present disclosure relates to generating illumination portions on a display that can be utilized to illuminate a subject of a front facing imaging device. A user of the device may want to illuminate the subject of the front facing imaging device to improve the quality of images captured by the front facing imaging device. For example, the subject may appear dark if additional illumination is not directed on to the subject. In some examples, the illumination portions of a display can be portions that are illuminated above a threshold luminosity to project light on a subject of the front facing imaging device. For example, the illumination portions can be illuminated to provide illumination on a subject of a front facing imaging device while other portions of the display can be illuminated to generate images on the display. In this way, the display can be utilized to generate images while also being utilized to provide illumination in the same direction as the generated images. In some examples, the illuminated portions can cover portions of selectable inputs for the generated images of a user interface, application window, or menu. In these examples, the selectable inputs can remain usable even when covered by the illumination portions. In this way, the display area can be utilized as an illumination device and user interface simultaneously.

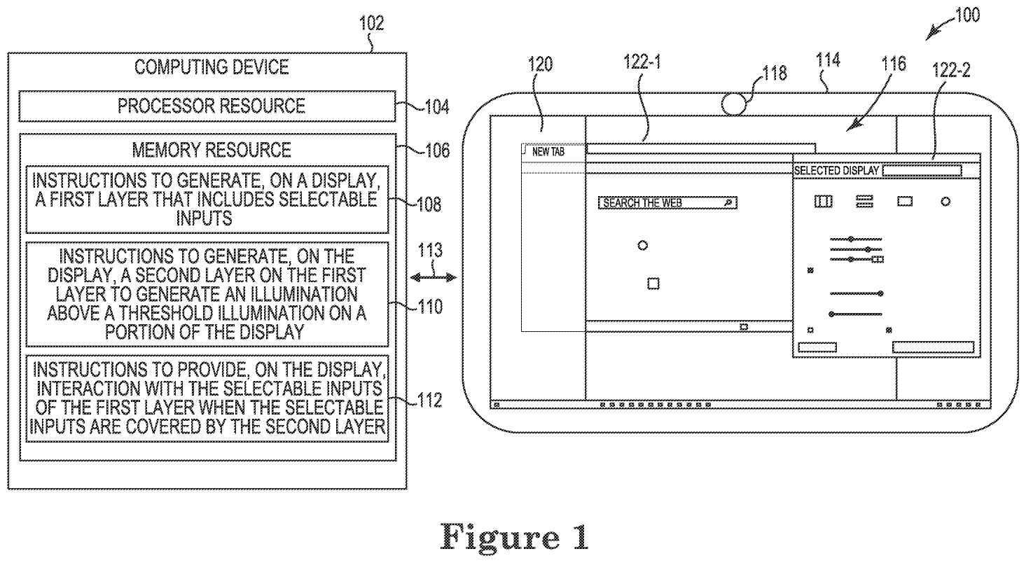

FIG. 1 is an example of a system 100 including a computing device 102 for generating illumination portions of a display 114. In some examples the computing device 102 can include a processor resource 104 communicatively coupled to a memory resource 106. As described further herein, the memory resource 106 can include instructions 108, 110, 112 that can be executed by the processor resource 104 to perform particular functions. In some examples, the computing device 102 can be associated with display 114. For example, the computing device 102 can be utilized to display images on the display 114. In some examples, the computing device 102 can be local or remote to the display 114. For example, the computing device 102 can be a cloud resource that is remote from the display 114.

In some examples, the computing device 102 can be communicatively coupled to the display 114 through a communication path 113. As used herein, a communication path, such as communication path 113, refers to a connection that allows signals to be transferred between devices. In these examples, the signals can be utilized to provide communication between different devices and/or components within a device. For example, the computing device 102 can utilize the communication path 113 to instruct an imaging device 118 associated with the display 114 to capture images of a subject. In some examples, images of the subject can be displayed within a first layer 116 and the illumination can be provided within a second layer 120. In some examples, the second layer 120 can be altered to increase or decrease in brightness to increase an image quality of captured images of the imaging device 118. For example, the computing device 102 can generate a second layer 120 or illumination portions to illuminate the subject being captured by the imaging device 118. In these examples, the computing device 102 can alter the illumination of the second layer 120 based on a determined subject lighting within an area of the display 114.

In some examples, the computing device 102 and the display 114 can be separate and distinct devices, however, the computing device 102 can also be incorporated as a portion of the display 114. For example, the computing device 102 can include a separate physical enclosure than the enclosure of the display 114. However, in other examples, the computing device 102 can be positioned within the enclosure of the display 114. That is, the computing device 102 can be hardware that is enclosed within the enclosure of the display 114.

In some examples, the display 114 can be associated with the imaging device 118. In some examples, the imaging device 118 can be a separate device from the display 114. For example, the imaging device 118 can be a video camera or webcam that can capture still images, video images, or other images of an area parallel to or in front of or facing the display 114. In this example, the imaging device 118 can be coupled to the enclosure of the display 114 through a mounting mechanism. As used herein, a mounting mechanism can include a physical structure to couple a first device to a second device. In other examples, the imaging device 118 can be embedded within the enclosure and/or frame that surrounds the display 114. In some examples, the captured images of the imaging device 118 can be displayed on the display 114 and/or transmitted to be displayed or utilized by a remote device, such as a remote computing device or remote display.

As described herein, the computing device 102 can be utilized to control functions of the display 114 and/or imaging device 118. The computing device 102 can include components such as a processor resource 104. As used herein, the processor resource 104 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 108, 110, 112. In other examples, the computing device 102 can include instructions 108, 110, 112 stored on a machine-readable medium (e.g., memory resource 106, non-transitory computer-readable medium, etc.) and executable by a processor resource 104. In a specific example, the computing device 102 utilizes a non-transitory computer-readable medium storing instructions 108, 110, 112 that, when executed, cause the processor resource 104 to perform corresponding functions.

In some examples, the computing device 102 can include instructions 108 that can be executed by a processor resource 104 to generate, on a display 114, a first layer 116 that includes selectable inputs 122-1, 122-2. In some examples, the selectable inputs 122-1, 122-2 can include menus, applications, windows, and/or other images that can be selected within a user interface displayed on the display 114. For example, the selectable input 122-1 can be an application window such as a web browser window. In some examples, the selectable input 122-1 can be utilized to provide inputs and/or display outputs of the computing device 102. The selectable input 122-2 can be separate from the selectable input 122-1. For example, the selectable input 122-1 can be utilized to control functions of a first application and the selectable input 122-2 can be utilized to control functions of a second application.

In some examples, the first layer 116 can include a portion of the display 114 that can be utilized to display a user interface that includes the selectable inputs 122-1, 122-2. The first layer 116 can be utilized to display images, video, among other features that can be generated by the computing device 102. In some examples, the first layer 116 can include a user interface of the computing device 102 and/or applications that are provided to the user interface by the computing device 102. In this way, the user interface or first layer 116 of the display 114 can be utilized to interact with the computing device 102 by displaying the selectable inputs 122-1, 122-2, images, videos, and/or other features.

In some examples, the computing device 102 can include instructions 110 that can be executed by a processor resource 104 to generate, on the display 114, a second layer 120 on the first layer 116 to generate an illumination above a threshold illumination on a portion of the display 114. In some examples, the second layer 120 can include an illumination portion of the display 114. As used herein, an illumination portion includes a portion of the display 114 that exceeds a particular illumination threshold to apply lighting in a parallel or substantially parallel direction with the display 114. For example, a user can be viewing the display 114 and the illumination portion can direct light toward the user. In some examples, the illumination portion can be utilized to provide additional lighting on a subject within the area of the display 114. In some examples, the second layer 120 on the portion of the display can include portions within the selectable inputs 122-1, 122-2. That is, the second layer 120 can cover a portion of the selectable inputs 122-1, 122-2.

As described herein, the imaging device 118 can be a front facing camera that can capture still images, video images, infrared images, and/or other types of images. As a front facing camera, the imaging device 118 may not include an integrated illumination device (e.g., light source, flash, etc.). In these examples, the imaging device 118 may not be capable of generating images above a particular quality threshold without additional illumination directed at a subject of the imaging device 118. For example, the images generated or captured by the imaging device 118 may appear dark or under illuminated when additional illumination devices are not utilized. Thus, the second layer 120 or illumination portions of the display 114 can be utilized to increase the image quality of images generated or captured by the imaging device 118.

In some examples, the computing device 102 can include instructions 112 that can be executed by a processor resource 104 to provide, on the display 114, interaction with the selectable inputs 122-1, 122-2 of the first layer 116 when the selectable inputs 122-1, 122-2 are covered by the second layer 120. As illustrated in FIG. 1, a portion of the selectable input 122-1 is positioned behind or is covered by the second layer 120. That is, the illumination portion or second layer 120 is covering or projected over a portion the selectable input 122-1. In some examples, the second layer 120 can be adjusted to different sizes across the display 114 and/or across the area of the selectable inputs 122-1, 122-2. In this way, the second layer 120 can be adjusted to different sizes and shapes across the display 114 without conforming or adapting to the borders of the selectable inputs 122-1, 122-2.

In some examples, the functions associated with the selectable inputs 122-1, 122-2 can continue or not be interrupted by the second layer 120. For example, the selectable inputs 122-1, 122-2 can be utilized behind or covered by the second layer 120 in the same or similar way as when the selectable inputs 122-1, 122-2 are not covered or positioned above the second layer 120. In some examples, the selectable inputs 122-1, 122-2 can include selectable tabs or images that can provide instructions or commands to the computing device 102. For example, the selectable input 122-1 can be a web browser that can include selectable tabs to display different images and/or access different web sites. In these examples, the selectable input 122-1 can continue to allow selections of selectable tabs that are covered by the second layer 120.

In some examples, the second layer 120 can include a plurality of features that can be altered or changed utilizing a selectable input 122-2. For example, the plurality of features can include, but are not limited to, a brightness level, an illumination level, a color, a size, a shape, a transparency, among other image features. In some examples, the selectable input 122-2 can be utilized to alter the second layer 120 as a plurality of portions. For example, the second layer 120 can be separated into a first portion (e.g., left portion, left side of the display 114, etc.) and a second portion (e.g., right portion, right side of the display 114, etc.).

In some examples, the plurality of portions can allow the second layer 120 to provide different illumination levels and/or different illumination properties to different sides of a subject of the imaging device 118. For example, a first portion of the second layer 120 can be positioned on a left side of the display 114 and a second portion of the second layer 120 can be positioned on a right side of the display 114. As described herein, the first portion of the second layer 120 can cover a portion of the selectable input 122-1 and the second portion of the second layer 120 may be covered by a portion of the selectable input 122-2.

In some examples, the first portion of the second layer 120 can have a first set of illumination properties and the second portion of the second layer 120 can have a second set of illumination properties that are different than the first set of illumination properties. For example, the first portion of the second layer 120 can be a first color with a first illumination level and the second portion of the second layer 120 can be a second color with a second illumination level. In some examples, the computing device 102 can alter a color of the second layer 120 to illuminate a subject within an area of the display 114 with the color. That is, the second layer 120 can illuminate the subject to appear with a corresponding color displayed by the second layer 120.

In some examples, the computing device 102 can alter the first portion of the second layer 120 to a first color to illuminate a first side of a subject within the area of the display 114 with the first color and alter the second portion of the second layer 120 to a second color to illuminate a second side of the subject within the area of the display with the second color. In some examples, the illumination level of the first portion of the second layer 120 can be lowered to allow the portion of the selectable input 122-1 to be viewable when the second layer 120 covers the portion of the selectable input 122-1. In this way, the display 114 can be utilized to provide illumination on to a subject of the imaging device 118 without lowering a working space (e.g., useable space, etc.) of the display 114.

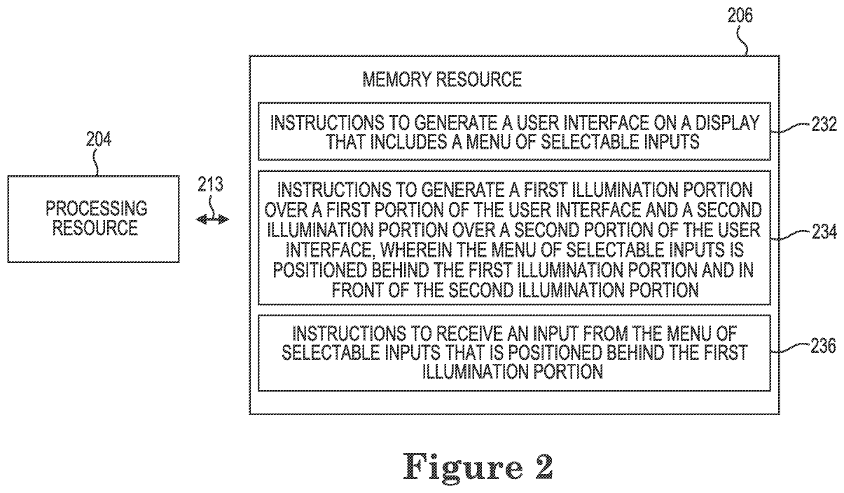

FIG. 2 illustrates an example of a memory resource 206 storing instructions for generating illumination portions on a display. In some examples, the memory resource 206 can be a part of a computing device or controller that can be communicatively coupled to a computing system that includes a display and/or imaging devices. For example, the memory resource 206 can be part of a computing device 102 as referenced in FIG. 1 and communicatively coupled to a display 114 as referenced in FIG. 1. In some examples, the memory resource 206 can be communicatively coupled to a processor resource 204 that can execute instructions 232, 234, 236 stored on the memory resource 206. For example, the memory resource 206 can be communicatively coupled to the processor resource 204 through a communication path 213. In some examples, a communication path 213 can include a wired or wireless connection that can allow communication between devices.

The memory resource 206 may be electronic, magnetic, optical, or other physical storage device that stores executable instructions. Thus, non-transitory machine readable medium (MRM) (e.g., a memory resource 206) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine readable medium (e.g., a memory resource 206) may be disposed within a controller and/or computing device. In this example, the executable instructions 232, 234, 236 can be “installed” on the device. Additionally, and/or alternatively, the non-transitory machine readable medium (e.g., a memory resource) can be a portable, external or remote storage medium, for example, that allows a computing system to download the instructions 232, 234, 236 from the portable/external/remote storage medium. In this situation, the executable instructions may be part of an “installation package”. As described herein, the non-transitory machine readable medium (e.g., a memory resource 206) can be encoded with executable instructions for generating illumination portions on the display to alter a luminosity at a subject.

The instructions 232, when executed by a processor resource such as the processor resource 204, can include instructions to generate a user interface on a display that includes a menu of selectable inputs. As described herein, a user interface can include an operating system for a computing device to allow a user to interact with and receive responses from the computing device. For example, the user interface can allow a user to provide commands to the computing device and the computing device can respond to the commands with particular functions. In some examples, the selectable inputs can include menus or other images that can be selected to provide a corresponding command to the computing device. For example, the selectable inputs can include an application window that can be selected by a user to initiate a corresponding command to the computing device.

In some examples, a menu of selectable inputs can include a window that includes a plurality of selectable inputs that can be selected to perform a particular function through a particular application of the user interface. For example, the menu of selectable inputs can include a menu to control or alter image settings of the display or illumination portions of the display. In this example, the menu of selectable inputs can be selectable images or box fields to enter values that can be received by the computing device to alter the display or illumination portions of the display to the selected values.

The instructions 234, when executed by a processor resource such as the processor resource 204, can include instructions to generate a first illumination portion over a first portion of the user interface and a second illumination portion over a second portion of the user interface, wherein the menu of selectable inputs is positioned behind the first illumination portion and in front of the second illumination portion. As described herein, an illumination portion (e.g., second layer 120 as referenced in FIG. 1, etc.) can be a separate layer or portion than the user interface or selectable inputs. In this way, the illumination portion can be manipulated, altered, and/or adjusted separately from the user interface and/or selectable inputs. Thus, the illumination portion may not be affected or altered based on a location of the selectable inputs and the selectable inputs may not be altered based on the location of the illumination portions. This can provide access or functionality to the entire display area even when illumination portions are displayed within the display area.

In some examples, the selectable inputs can be positioned behind the first illumination portion and in front of the second illumination portion. As described herein, the first illumination portion, the second illumination portion, and the user interface can be controlled and/or adjusted independently. In this way, the first illumination portion can be positioned over or positioned to cover a portion of the selectable inputs and the second illumination portion can be positioned behind or covered by a portion of the selectable inputs. In some examples, the memory resource 206 can include instructions that can be executed by the processor resource 204 to adjust a color of the first illumination portion independent of the second illumination portion such that the first illumination portion is a first color and the second illumination portion is a second color.

Whether or not the selectable inputs are covered by an illumination portion, the selectable inputs can be utilized. For example, the portion of the selectable inputs that is covered by the first illumination portion can be utilized in the same or similar way as the selectable inputs that are not covered by an illumination portion. For example, a selectable input can be covered by the first illumination portion. In this example, the selectable input can be selected through the first illumination portion. In some examples, the selectable input may not be viewable through the illumination portion, but may still be selectable through the first illumination portion. In other examples, the illumination portion can generate an outline of the selectable inputs that are covered by the illumination portion to allow the selectable inputs to be selected through the illumination portion.

The instructions 236, when executed by a processor resource such as the processor resource 204, can include instructions to receive an input from the menu of selectable inputs that is positioned behind the first illumination portion. As described herein, the menu of selectable inputs can include a plurality of selectable inputs that can each be selectable by a user to provide a corresponding instruction for the computing device. For example, the menu of selectable inputs can include a menu of a web browser that includes selectable inputs such as a: “forward input”, “backward input”, “search input”, “home input”, “website input”, among other inputs that can be provided to navigate a website, local area network, and/or wide area network. In this example, a portion of the plurality of inputs can be covered by the first illumination portion and the portion of the plurality of inputs can continue to be utilized through the first illumination portion. This can provide more functional area of the display when utilizing a plurality of illumination portions.

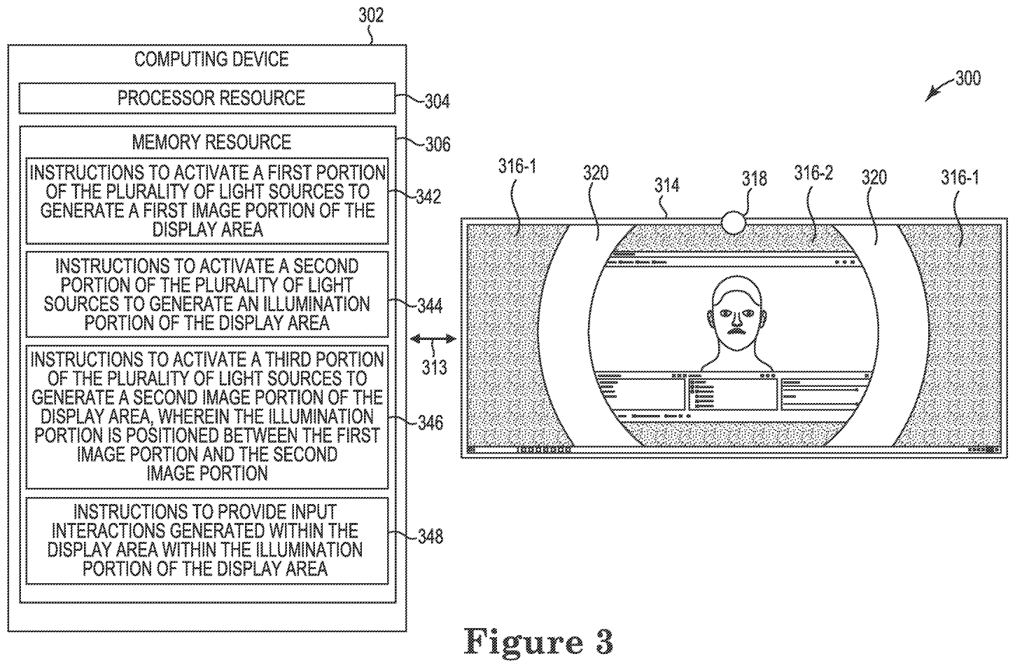

FIG. 3 illustrates an example of a system 300 including a computing device 302 for generating illumination portions on a display 314. In some examples the computing device 302 can be a device that includes a processor resource 304 communicatively coupled to a memory resource 306. As described further herein, the memory resource 306 can include or store instructions 342, 344, 346, 348 that can be executed by the processor resource 304 to perform particular functions.

In some examples, the computing device 302 can include instructions 342 that can be executed by a processor resource 304 to activate a first portion of a plurality of light sources to generate a first image portion (e.g., first portion of a first layer 316-1) of the display area. In some examples, the first image portion of the display area can include a first menu of selectable inputs. In some examples, the first image portion of the display area can include a first layer 316-1 of a display that can include a user interface as described herein. In some examples, the first image portion can be separate from other image portions. In some examples, a first image portion can be separated from other image portions by a defined border. In other examples, the first image portion can be separated from other image portions by an illumination portion such as a second layer 320. In this way, the first image portion can be independently controlled or altered independently from other image portions. For example, the second layer 320 can include a defined area within the display area that is to be utilized as an illumination portion. In this example, the pixels or light sources of the display area within the illumination portion can be illuminated to an illumination level that exceeds an image illumination level. As used herein, an image illumination level can include a level of illumination that can be utilized to display images on the display. For example, the pixels or light sources within the portion defined by the second layer 320 can appear as white or substantially white to provide additional light on a subject.

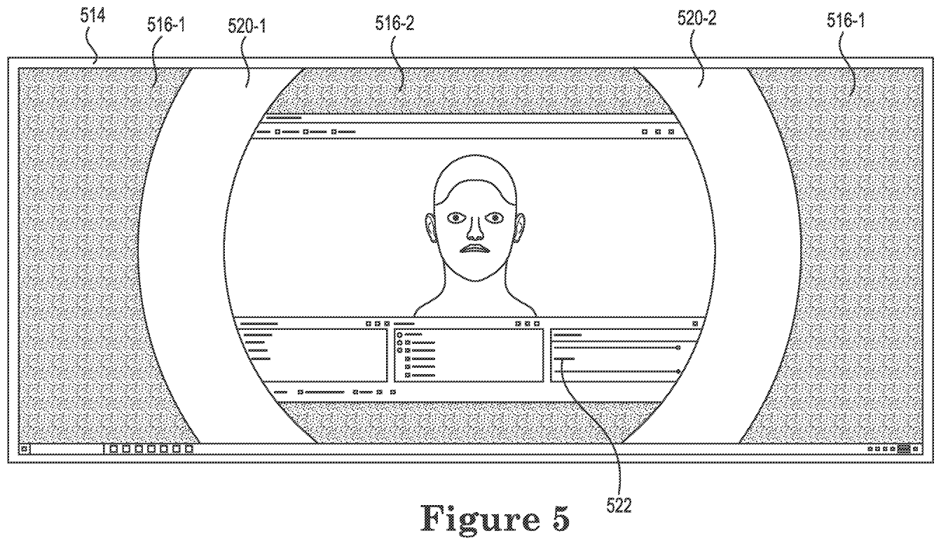

In some examples, the second layer 320 can be defined areas that include a plurality of different shapes and/or sizes that can be adjusted utilizing a user interface. For example, the second layer 320 can include a rectangular or square shape that can be positioned on a side of the display area. In this way, the second layer 320 can cover two of the four corners of a display area. In some examples, the second layer 320 can include an additional rectangular or square shape positioned on another side of the display area such that the second layer 320 covers all four corners, as illustrated in FIG. 1. In further examples, the second layer 320 may be a rectangular frame or border extending around a periphery of the display area. In other examples, the second layer 320 can be a defined area of an oval or circular shape that can be adjusted to surround a portion of the display area. Other shapes and/or sizes of the second layer 320 can be utilized to allow the first layer 316-1, 316-2 or particular selectable inputs to be uncovered by the second layer 320 and viewable by a user. For example, the second layer 320 can include a circular shape that can uncover an inner portion of the first layer 316-2 and uncover an outer portion of the first layer 316-1. This is described further in reference to FIG. 5.

In some examples, the computing device 302 can include instructions 344 that can be executed by a processor resource 304 to activate a second portion of the plurality of light sources to generate an illumination portion of the display area (e.g., second layer 320). In some examples, the plurality of light sources can be the same or similar light sources that generate images within the first layer 316-1, 316-2. For example, the first layer 316-1, 316-2 can include a plurality of pixels that can be utilized to generate images (e.g., menus, backgrounds, videos, etc.). In this example, the pixels within the second layer 320 can be illuminated to a level that exceeds an illumination threshold and utilized as an illumination portion. In some examples, the illumination portion or second layer 320 can be utilized to provide additional light on a subject in front or across from the display 314. For example, the imaging device 318 can be a camera to capture images that are in front of the display 314. In this example, the illumination portion or second layer 320 can be utilized to provide illumination within the area captured by the imaging device 318.

In some examples, the computing device 302 can include instructions 346 that can be executed by a processor resource 304 to activate a third portion of the plurality of light sources to generate a second image portion (e.g., second portion of the first layer 316-2) of the display area. As described herein, the second image portion can be physically separated from the first image portion. For example, the first image portion of the first layer 316-1 can include a first border and the second image portion of the first layer 316-1 can include a second border to separate the first image portion of the first layer 316-1 and the second image portion of the first layer 316-2. In other examples, the first image portion of the first layer 316-1 can be a first portion of a user interface and the second image portion of the first layer 316-2 can be a second portion of the user interface.

In some examples, the illumination portion or second layer 320 can be positioned between the first image portion of the first layer 316-1 and the second image portion of the first layer 316-2. In some examples, the illumination portion or second layer 320 can be in the shape of circle or oval that is overlaid on the display 314. In this way, an exterior edges of the illumination portion can include the first image portion of the first layer 316-1 and the interior portion of the illumination portion can include the second image portion of the first layer 316-2. In this way, the illumination portion or second layer 320 can separate the first image portion of the first layer 316-1 from the second image portion of the first layer 316-2.

In some examples, the computing device 302 can include instructions 348 that can be executed by a processor resource 304 to provide input interactions generated within the display area within the illumination portion (e.g., second layer 320) of the display area. As described herein, the illumination portion or second layer 320 can be displayed over the first image portion of the first layer 316-1 and/or the second image portion of the first layer 316-2. In these examples, the portions of the first image portion of the first layer 316-1 and the second image portion of the first layer 316-2 that are covered by the illumination portion or second layer 320 can still be accessed through the illumination portion or second layer 320 to allow a user to utilize the functions that are covered by the illumination portion or second layer 320.

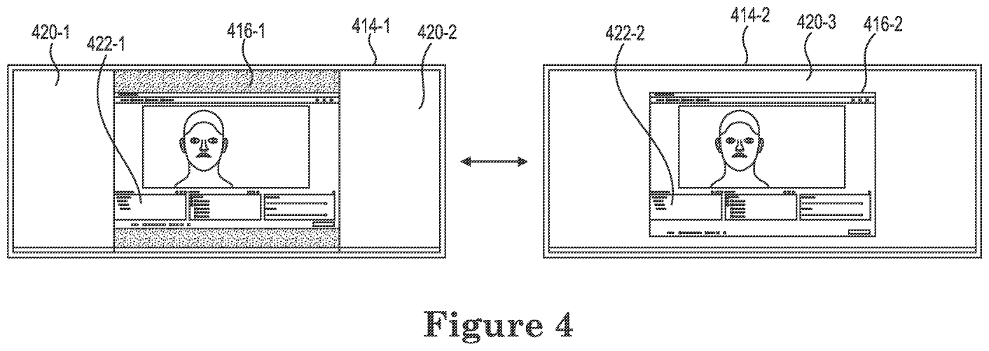

FIG. 4 illustrates a display 414 with generated illumination portions 420. FIG. 4 illustrates a first display 414-1 and a second display 414-2. The first display 414-1 and a second display 414-2 can illustrate the same display 414 at different times. For example, the first display 414-1 can illustrate a first set of settings or properties and the second display 414-2 can illustrate a second set of settings or properties. The first display 414-1 can illustrate a first illumination portion 420-1 on a first side of an image portion 416-1 and a second illumination portion 420-2 on a second side of an image portion 416-1.

As described herein, the first illumination portion 420-1 can be altered in size, shape, color, and/or luminosity level independent of the second illumination portion 420-2. In addition, the first illumination portion 420-1 and/or the second illumination portion 420-2 can be altered and/or controlled independently of the image portion 416-1. In this way, a subject of an imaging device can utilize different lighting for each side by independently altering the first illumination portion 420-1 and the second illumination portion 420-2. In some examples, the image portion 416-1 can include a background of a user interface and an application window that includes selectable inputs 422-1. As described herein, the selectable inputs can be utilized to provide commands to a computing device.

In some examples, the second display 414-2 can illustrate when an illumination portion 420-3 extends across the entire second display 414-2. In some examples, the first illumination portion 420-1 can be extended to the middle and the second illumination portion 420-2 can be extended to the middle of the display 414-2 to make it appear as a single illumination portion 420-3. In these examples, the illumination portion 420-3 can include a plurality of portions that can each be independently controlled as described herein. In some examples, the illumination portion 420-3 can be positioned over the image portion 416-2 and/or over a portion of the image portion 416-2. For example, a background or user interface portion of the image portion 416-2 can be covered by the illumination portion 420-3. In this way, the background or user interface portion of the image portion 416-2 may not visible. However, as described herein, the background or user interface portion of the image portion 416-2 may still be utilized and provide the same or similar functions as if it were not covered by the illumination portion 420-3. For example, the image portion 416-2 can provide the same or similar functions as the image portion 416-1.

In some examples, particular selectable inputs 422-2 can be covered or positioned behind the illumination portion 420-3. In some examples, outlines of the selectable inputs 422-2 can be projected through the illumination portion 420-3 to allow the selectable inputs 422-2 to be viewed such that the selectable inputs 422-2 can be identified and more easily selected through the illumination portion 420-3. In this way, the illumination portion 420-3 can provide the additional lighting toward a subject while allowing the selectable inputs 422-2 to be selected through the illumination portion 420-3.

FIG. 5 illustrates a display 514 with generated illumination portions. In some examples, the display 514 can be the same or similar display as described herein. For example, the display 514 can be communicatively coupled to a computing device and be utilized to display a user interface. In some examples, the display 514 can include a first image portion 516-1 and a second image portion 516-2. In some examples, the first image portion 516-1 can be separated from the second image portion 516-2 by an illumination portion 520-1 and/or illumination portion 520-2. In some examples, the illumination portions 520-1, 520-2 can act as a single illumination portion 520.

In some examples, the illumination portions 520-1, 520-2 can be positioned or overlaid over the image portions 516-1, 516-2. In this way, the illumination portions 520-1, 520-2 may obscure, block, or otherwise cover the image portions 516-1, 516-2 that are behind the illumination portions 520-1, 520-2. The illumination portions 520-1 and 520-2 may be illuminated above an illumination threshold in order to obscure the image portions 516-1 and 516-2. As described herein, the image portions 516-1, 516-2 can remain functional even when they are positioned behind the illumination portions 520-1, 520-2. For example, the image portion 516-2 can include selectable inputs 522. As illustrated in FIG. 5, a portion of the selectable inputs 522 can be covered by the illumination portion 520-2. However, the selectable inputs 522 that are positioned behind the illumination portion 520-2 can remain selectable through the illumination portion 520-2 even if they are not visible through the illumination portion 520-2. In this way, the display 514 can include the same or similar quantity of selectable inputs 522 across the display area and simultaneously provide additional lighting through the illumination portions 520-1, 520-2.

In some examples, the illumination portions 520-1, 520-2 can create a circle or oval shape within the display area of the display 514. In some examples, the circle or oval shape can include an inner portion that can be utilized to display the image portion 516-2 and an outer portion that can be utilized to display the image portion 516-1. In some examples, a computing device can alter a size and illumination level of the illumination portions 520-1, 520-2 based on an image captured by the imaging device. In some examples, the diameter or shape of the inner portion can be altered or changed independently of the diameter or shape of the outer portion. That is, the size and/or shape of the first image portion 516-1 can be altered independently of the size and/or shape of the second image portion 516-2. Thus, a computing device can alter an interior diameter of the illumination portion 520-1, 520-2 and an exterior diameter of the illumination portion 520-1, 520-2 based on an image property of a subject captured by an imaging device. As described herein, the illumination portions 520-1, 520-2 can have particular properties that can each be independently altered to display different lighting settings on subject within the area of the display 514.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processor resource; and
a non-transitory memory resource storing machine-readable instructions stored thereon that, when executed, cause the processor resource to:
generate, on a display, a first layer that includes selectable inputs;
generate, on the display, a second layer on the first layer to generate an illumination above a threshold illumination on a portion of the display; and
provide, on the display, interaction with the selectable inputs of the first layer when the selectable inputs are covered by the second layer.

2. The computing device of claim 1, wherein the processor resource is to alter the illumination based on a determined subject lighting within an area of the display.

3. The computing device of claim 1, wherein the portion of the display includes portions within the selectable inputs.

4. The computing device of claim 1, wherein the processor resource is to alter a color of the second layer to illuminate a subject within an area of the display with the color.

5. The computing device of claim 1, wherein the portion includes a first portion that is illuminated at a first illumination level and a second portion that is illuminated at a second illumination level.

6. The computing device of claim 5, wherein the processor resource is to alter the first portion to a first color to illuminate a first side of a subject within an area of the display with the first color and alter the second portion to a second color to illuminate a second side of the subject within the area of the display with the second color.

7. The computing device of claim 1, wherein a first portion of the selectable input is covered by the second layer and a second portion of the selectable input covers the second layer.

8. A non-transitory memory resource storing machine-readable instructions stored thereon that, when executed, cause a processor resource to:
generate a user interface on a display that includes a menu of selectable inputs;
generate a first illumination portion over a first portion of the user interface and a second illumination portion over a second portion of the user interface, wherein the menu of selectable inputs is positioned behind the first illumination portion and in front of the second illumination portion; and
receive an input from the menu of selectable inputs that is positioned behind the first illumination portion.

9. The memory resource of claim 8, wherein the processor resource is to adjust a brightness of the first illumination portion independent of the second illumination portion.

10. The memory resource of claim 8, wherein the processor resource is to adjust a color of the first illumination portion independent of the second illumination portion such that the first illumination portion is a first color and the second illumination portion is a second color.

11. The memory resource of claim 8, wherein the processor resource is to alter the first illumination portion over the first portion of the user interface to make the menu of selectable inputs visible behind the first illumination portion.

12. A system, comprising:
a display device including an enclosure that surrounds a display area of the display device;
a plurality of light sources to generate images on the display area;
an imaging device to capture an image of a subject; and
a processor resource to:
activate a first portion of the plurality of light sources to generate a first image portion of the display area;
activate a second portion of the plurality of light sources to generate an illumination portion of the display area;
activate a third portion of the plurality of light sources to generate a second image portion of the display area, wherein the illumination portion is positioned between the first image portion and the second image portion; and
provide input interactions generated within the display area within the illumination portion of the display area.

13. The system of claim 12, wherein the processor resource is to alter a size and illumination level of the illumination portion based on an image captured by the imaging device.

14. The system of claim 12, wherein the processor resource is to alter a shape and size of the illumination portion based on a location of the subject captured by the imaging device.

15. The system of claim 12, wherein the processor resource is to alter an interior diameter of the illumination portion and an exterior diameter of the illumination portion based on an image property of the subject captured by the imaging device.
